(19) United States
(12) Patent Application Publication
(10) Pub. No.: US 2025/0376048 A1
(43) Pub. Date: Dec. 11, 2025

(54) PIVOTING BOOM STRUCTURE FOR DYNAMIC ENERGY TRANSFER SYSTEM

(71) Applicant: Caterpillar Inc., Peoria, IL (US)

(72) Inventors: Igor STRASHNY, Tucson, AZ (US); Nitin R. PATEL, Tucson, AZ (US); Jason R. SCHAFER, Rapid City, SD (US); Kurt L. WINCKLER, Tucson, AZ (US); Stephen HERD, Durham (GB); Paul IVES, Twin Lake, MI (US)

(73) Assignee: Caterpillar Inc., Peoria, IL (US)

(21) Appl. No.: 19/228,126

(22) Filed: Jun. 4, 2025

Related U.S. Application Data
(60) Provisional application No. 63/657,160, filed on Jun. 7, 2024.

(51) Int. Cl. B60L 50/53; B60L 53/16

(52) U.S. Cl. CPC B60L 50/53; B60L 53/16

(57) ABSTRACT

A rail connector assembly for connecting a mobile machine to an electrically-conducting rail system includes a boom assembly, a trailing arm assembly and a contactor assembly. The boom assembly includes a main boom and a boom tip. A first end of the main boom is configured to be coupled to the mobile machine, and a second end of the main boom opposite to the first end is pivotably coupled to the boom tip. The boom tip includes an angled portion that extends at a non-zero angle from a longitudinal axis of the main boom. The trailing arm assembly is pivotably coupled to an end of the boom tip. The contactor assembly is pivotably coupled to an end of the trailing arm assembly.

### CROSS-REFERENCE TO RELATED APPLICATION

This application claims the benefit of priority to U.S. Provisional Patent Application No. 63/657,160, filed on Jun. 7, 2024, the entirety of which is incorporated herein by reference.

### TECHNICAL FIELD

The present disclosure relates generally to a boom structure for a mobile machine, and more specifically, to a pivoting boom for connecting an electrically-powered machine to an electrically-conducting rail system.

### BACKGROUND

Mobile industrial machines, such as earth-moving machines, can be of substantial weight and can bear immense loads, thus requiring a significant amount of power. Many industrial machines are driven by internal combustion engines. However, internal combustion engines have drawbacks in the form of fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present unique challenges. For example, the use of hybrid or all-electric systems in an industrial capacity requires a significant investment in infrastructure, particularly due to the location of industrial worksites. While the use of overhead electricity-conducting rails has been one solution for powering vehicles with predetermined routes or terrain (e.g., trains, subways, buses, etc.), freely-steerable industrial machines and worksites with uneven terrain present hurdles. As a result, existing powered systems, such as overhead trolleys, are not typically used in remote and uneven environments.

Other problems include the ability to safely generate and conduct electricity while ensuring safety. As industrial machine routes may frequently change due to project needs, it is important for the machine systems to securely conduct power to the mobile machine. It is also beneficial for the industrial machine to have control systems with the ability to quickly deploy or retract the connector assembly.

An electric delivery system for providing electric power to a traveling vehicle is disclosed in International Patent App. Pub. No. WO 2020/186296 A1, published on Sep. 24, 2020 (“the '296 publication”). The '296 publication describes an electric delivery system at a mine site for a moving vehicle where two conductors are anchored to relocatable roadside barriers. In order to charge the moving vehicle, the delivery system requires that a retractable arm precisely engage with electrical connectors embedded within a horizontal channel of the roadside barriers.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a rail connector assembly for connecting a mobile machine to an electrically-conducting rail system may include a boom assembly, a trailing arm assembly and a contactor assembly. The boom assembly may include a main boom and a boom tip. A first end of the main boom may be configured to be coupled to the mobile machine, and a second end of the main boom opposite to the first end may be pivotably coupled to the boom tip. The boom tip may include an angled portion that extends at a non-zero angle from a longitudinal axis of the main boom. The trailing arm assembly may be pivotably coupled to an end of the boom tip. The contactor assembly may be pivotably coupled to an end of the trailing arm assembly.

In another aspect, an electrically-powered mobile machine may include a machine frame, a motor configured to operate a function of the mobile machine, and a connector assembly coupled to a portion of the machine frame via a boom bracket. The connector assembly may be configured to connect to an electrically-conductive rail for supplying electrical energy to at least one of a storage device or the motor. The connector assembly may include a boom assembly, a trailing arm assembly, and a contactor assembly. The boom assembly may include a main boom and a boom tip. A first end of the main boom may be configured to be coupled to the mobile machine, and a second end of the main boom opposite to the first end may be pivotably coupled to the boom tip. The boom tip may include an angled portion that extends at a non-zero angle from a longitudinal axis of the main boom. The trailing arm assembly may be pivotably coupled to an end of the boom tip. The contactor assembly may be pivotably coupled to an end of the trailing arm assembly.

In yet another aspect, a rail connector assembly for connecting a mobile machine to an electrically-conducting rail system may include a boom assembly, a trailing arm assembly, and a contactor assembly. The boom assembly may include a main boom and a boom tip. A first end of the main boom may be configured to be coupled to the mobile machine, and a second end of the main boom opposite to the first end may be pivotably coupled to the boom tip. The trailing arm assembly may be pivotably coupled to an end of the boom tip. The trailing arm may include at least a first arm and a second arm. The second arm may include an angled portion that extends at non-zero angles from both first and second end portions of the second arm. The contactor assembly may be pivotably coupled to an end of the trailing arm assembly. The rail connector assembly may also include a plurality of cable protectors that may at least partially overlap with one or more portions of the trailing arm assembly.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electric mobile machine connected to a conducting rail power source using a rail connector assembly with a pivoting boom, trailing arm, and connector, according to aspects of the present disclosure.

FIG. 2A is a perspective view of a portion of the mobile machine and the rail connector assembly in a stowed configuration.

FIG. 2B is a perspective view of a portion of the mobile machine and the rail connector assembly in an at least partially extended configuration

FIG. 3A is another perspective view of a portion of the mobile machine and the rail connector assembly in the stowed configuration.

FIG. 3B is a perspective view of a portion of the mobile machine and a portion of the rail connector assembly, with the rail connector assembly in the at least partially extended configuration.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value. Additionally, the terms “proximal” and “distal” are used herein to refer to the relative positions of the components of an exemplary machine and/or a rail connector assembly (e.g., boom assembly and other components) coupled to an exemplary machine. When used herein, “proximal” refers to a position relative to closer to the center or middle of the machine. In contrast, “distal” refers to a position relatively further away or extended from the center or middle of the machine.

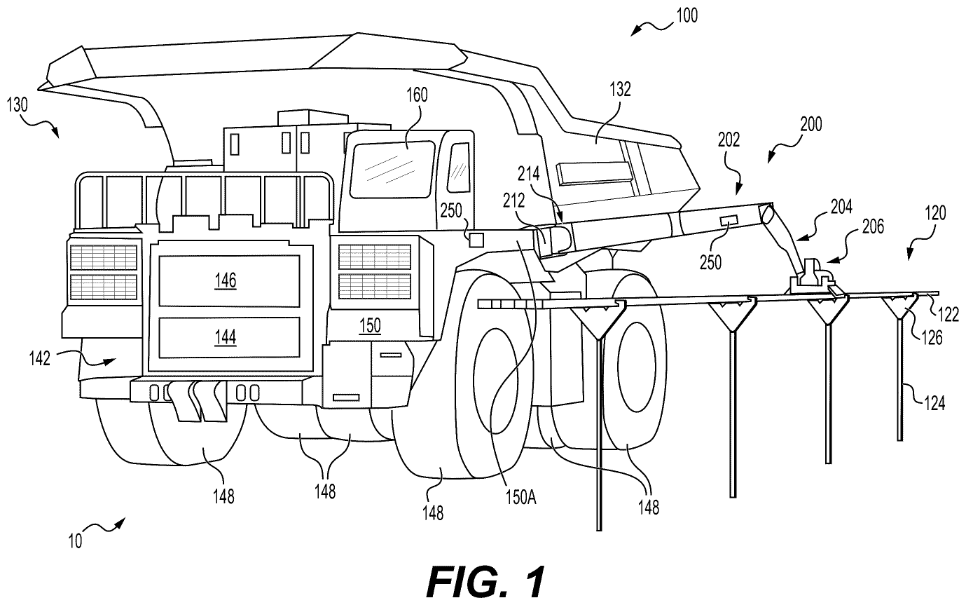

FIG. 1 depicts a mobile machine power system 100, according to aspects of the present disclosure. The mobile machine power system 100 includes an electrically-conducting rail system 120 and a mobile machine 130. The electrically-conducting rail system 120 includes a plurality of conductor rails 122 connected to a power-generating source (not shown), a plurality of support poles 124 secured to a ground surface 10, and a bracket assembly 126 attached to a top end of the each of the support poles 124 to retain the plurality of conducting rails 122 in a secured position (e.g., elevated above the ground). Although not shown, the power-generating source may be, for example, a power grid, one or more generators, and/or one or more energy storage devices. Additionally, as discussed in detail below, mobile machine 130 may include a transport portion or bed 132, for example, to be loaded with and convey one or more materials. Furthermore, mobile machine 130 may include or be coupled to a rail connector assembly 200, for example, to electrically connect mobile machine 130 to one or more portions of electrically-conducting rail system 120, for example, to help power, charge, or otherwise supply electrical energy from electrically-conducting rail system 120 to mobile machine 130.

Although FIG. 1 shows an example where the plurality of conductor rails 122 contains three conductor rails, the plurality of conductor rails 122 may contain fewer or more rails. In this example, two of the conductor rails provide electrical power at different polarities while the third conductor rail provides a reference of 0 volts. The electrically conducting rail system may alternatively incorporate a three-phase power system, utilizing a three-rail power circuit in addition to a fourth conductor rail providing a reference of 0 volts.

The plurality of support poles 124 ground the electrically-conducting rail system 120, specifically contacting the conductor rail to provide the reference of 0 volts. Individual support poles 124 may be rods, poles, posts, cylinders, stanchions, or similar structures and have a length for elevating and supporting the plurality of conductor rails 122. The plurality of support poles 124 have a length sufficient to support and stabilize the plurality of conducting rails 122 at a height above the ground 10, for example, at a height of at least eight feet above the ground 10. The support poles 124 may be formed of dielectric materials such as pultruded fiberglass-reinforced polymer (FRP), or other electrically insulating or dielectric materials. Additionally, rail system 120 may be positioned adjacent to a portion of the ground 10 along a portion of a work route or path to be traversed by mobile machine 130. In some aspects, rail system 120 may be positioned adjacent to an uphill portion of the work route or path, for example, adjacent to an uphill portion of the work route or path that mobile machine 130 will traverse while loaded (e.g., carrying one or more materials). Furthermore, in some aspects, rail system 120 may be positioned such that conductor rails 122 are spaced away from the work route or path that mobile machine 130 will traverse, for example, by approximately 10 feet to approximately 16 feet (e.g., approximately 3 meters to approximately 5 meters).

When in operation, mobile machine 130 and its various systems may be controlled via a machine operator located in an operator cabin 160. Operator cabin 160 may be in a front or forward portion of mobile machine 130. In some aspects, mobile machine 130 may be semi- or fully-autonomous or remotely operated. If fully-autonomous or remotely operated, mobile machine 130 may not include operator cabin 160. In any of these aspects, mobile machine 130 is free-steering and includes an electric drive system 142. Electric drive system 142 may include at least one electric motor 144 and/or at least one battery system 146. Electric motor 144 may be configured to operate a function of mobile machine 130, for example, to provide power to electric drive system 142. Battery system 146 may be configured to store electrical energy and/or provide electrical energy to electric motor 144. Electric drive system 142 may be operably coupled to and drive a set of ground-engaging elements 148, such as tires or continuous tracks, for propelling and maneuvering the mobile machine.

Mobile machine 130 also includes a frame 150 which supports the mobile machine's mechanical components. Machine frame 150 may be the structural support components of mobile machine 130. Alternatively or additionally, machine frame 150 may include the external structure(s) of a body of mobile machine 130. As mentioned above and as discussed in detail below, mobile machine 130 may include or be coupled to rail connector assembly 200. Rail connector assembly 200 may be movably coupled to frame 150, for example, to one or more beams, rods, plates, or other portions of frame 150. In some aspects, rail connector assembly 200 may be coupled to one or more beams of a rollover protection structure of mobile machine 130. For example, rail connector assembly 200 may be movably coupled to a portion of frame 150 below or adjacent to operator cabin 160 and/or in a longitudinal middle portion of mobile machine 130 (e.g., between forward ground engaging elements 148 and rear ground engaging elements 148). Moreover, a portion of rail connector assembly 200 may extend away from frame 150 and connect to electrically-conducting rail system 120. In these aspects, rail connector assembly 200 may help to transfer electrical energy from electrically-conducting rail system 120 to mobile machine 130. Mobile machine 130 may utilize either hybrid or all-electric power systems, and the electrically-conducting rail system 120 may be applied to either system.

As shown in FIG. 1, the exemplary mobile machine 130 travels along the work route or path, with the electrically-conducting rail system 120 positioned along a route or path parallel or adjacent to at least a portion of the defined work route. It is noted that the mobile machine 130 is shown in the context of a mining truck. In these aspects, the work route or path may lead from a mining source to another destination within the worksite. The present disclosure is not thereby limited, however, and other types of machines and applications or worksite are within the scope of the present disclosure, including articulated trucks, asphalt pavers, backhoe loaders, cold planers, compactors, dozers, draglines, drills, rope shovels, excavators, forest machines, hydraulic mining shovels, material handlers, motor graders, off-highway trucks, pipelayers, road reclaimers, skid steer and compact track loaders, telchandlers, track loaders, underground mining dump loaders and trucks, wheel loaders, wheel tractor-scrapers, or other machines.

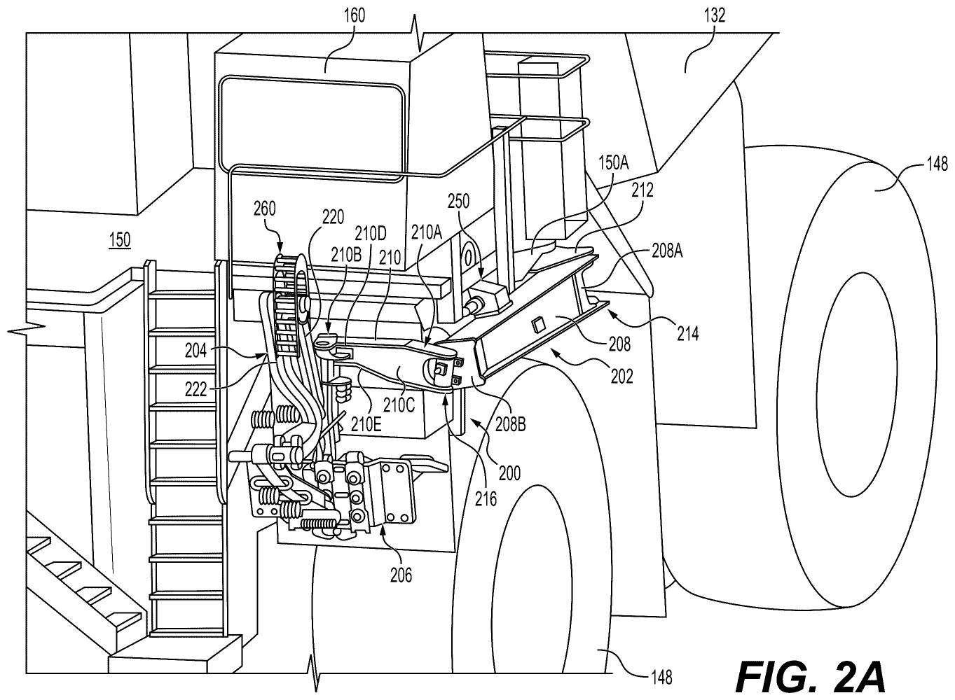

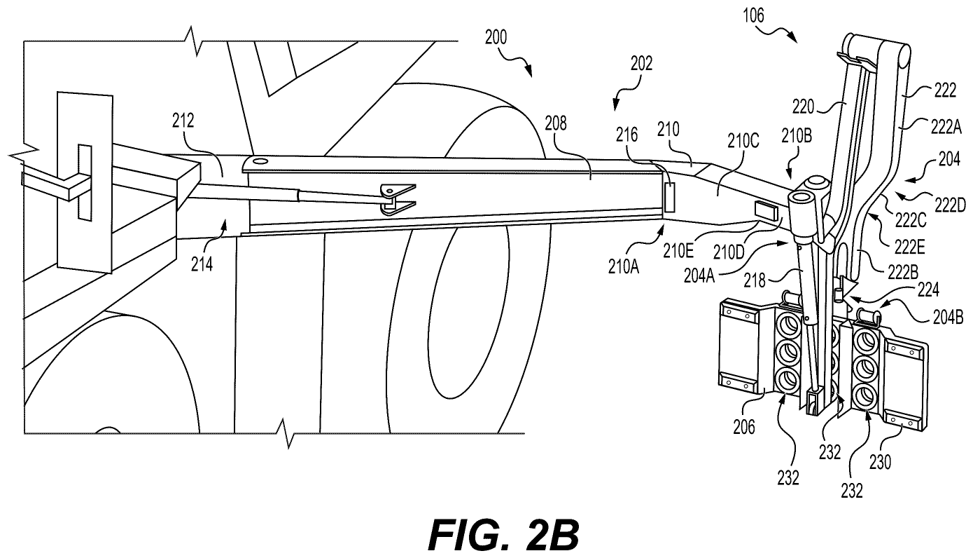

As shown in FIG. 1, rail connector assembly 200 may be controlled by an operator to electrically connect mobile machine 130 to electrically-conducting rail system 120. For example, rail connector assembly 200 includes a boom assembly 202, an extension or arm (e.g., trailing arm assembly 204) that can extend and/or trail from boom assembly 202, and a hat or contactor assembly 206. It is noted that FIG. 1 illustrates boom assembly 202, trailing arm assembly 204, and contactor assembly 206 schematically, and the other Figures illustrate additional details of the various assemblies. One or more of boom assembly 202, trailing arm assembly 204, and/or contactor assembly 206 may be pivotable or movable (e.g., extendable and retractable) to electrically connect to one or more portions of rail system 120. As discussed below, rail connector assembly 200 may be movable between at least a retracted or stowed configuration (e.g., FIG. 2A) and a pivoted or extended configuration (FIGS. 1 and 2B).

As shown in FIGS. 2A and 2B, boom assembly 202 may be a two-part boom assembly, including a main boom 208 and a boom tip 210. A first or proximal end 208A of main boom 208 may be coupled to a portion of machine frame 150, for example, via a boom bracket 212. Boom assembly 202 may be pivotable or rotatable relative to machine frame 150 via one or more pivotable connections 214 between proximal end 208A of main boom 208 and boom bracket 212. As discussed in detail below, boom assembly 202 may be secured to another portion of machine frame 150 via one or more boom lock assemblies 250. Boom bracket 212 is shown as being mounted to machine frame 150 such that main boom 208 pivots about a vertical axis. However, this disclosure is not so limited, and boom bracket 212 may be mounted to or otherwise coupled to machine frame 150 in other configurations and/or main boom 208 may otherwise pivotable relative to boom bracket 212 and/or machine frame 150.

Boom assembly 202 may be attached to a side surface 150A (e.g., a lateral side and/or side parallel to a direction of travel of machine 130) of frame 150 to pivot or rotate about a joint or pivotable connection(s) 214. Although boom assembly 202 is shown to be attached to a mining haul truck, boom assembly 202 is capable of being incorporated in various types of mobile machines 130, as boom bracket 212 may be an interchangeable adapter that is specific to the type of machine being operated.

Additionally, a second or distal end 208B of main boom 208 (e.g., opposite to first or proximal end 208A) may be coupled to boom tip 210. For example, boom tip 210 may be pivotably or rotatably connected to distal end 208B of main boom 208 via another pivotable connection 216 (e.g., a pivotable boom connection) between distal end 208B of main boom 208 and boom tip 210 (e.g., a proximal end 210A of boom tip 210). One or more of pivotable connection 214 and pivotable boom connection 216 may be hydraulically, electrically, and/or pneumatically controlled, for example, to control the position of main boom 208 relative to boom bracket 212 and machine frame 150 and/or the position of boom tip 210 relative to main boom 208. Alternatively or additionally, one or more of pivotable connection 214 and pivotable boom connection 216 may be controlled via one or more motors (not shown). In some aspects, a rotary actuator (e.g., between main boom 208 and boom tip 210) may control the position of boom tip 210 relative to main boom 208, for example, forming an adjustable knuckle joint.

As mentioned, boom tip 210 includes proximal end 210A. Additionally, boom tip 210 includes a distal end 210B, for example, opposite to proximal end 210A. As shown, in some aspects, boom tip 210 includes an angled portion 210C extending between proximal end 210A and distal end 210B. For example, angled portion 210C may extend upward at a non-zero angle (e.g., between approximately 15 degrees to approximately 75 degrees, between approximately 30 degrees and approximately 60 degrees, for example, approximately 45 degrees) from a longitudinal axis of main boom 208 and pivotable boom connection 216. In some aspects, the angle that angled portion 210C extends from the longitudinal axis of main boom 208 may be adjustable. Moreover, boom tip 210 may include an end portion 210D, for example, distal of angled portion 210C. End portion 210D may extend parallel to the longitudinal axis of main boom 208 and pivotable boom connection 216. As a result, boom tip 210 may include a bent portion 210E, for example, formed by the coupling of angled portion 210C to end portion 210D. It is understood, that in some arrangements, boom tip 210 may not include angled portion 210C. Rather, in some arrangements in which boom assembly 202 is connected to machine 130 at a height sufficient to permit the boom assembly 202 to transition between the stowed and extended positions without interfering with (contacting, hitting, etc.) other portions of mobile machine 130, rail system 120, the ground surface 10, or other objects, boom tip 210 may omit angled portion 210C and instead, include a generally straight or planar surface extending between proximal end 210A and distal end 210B. That is, characteristics of the boom tip 210 may vary depending on the mobile machine 130 with which the boom tip 210 is utilized.

Additionally, trailing arm assembly 204 may be coupled to boom tip 210, for example, to distal end 210B of boom tip 210. For example, a proximal end 204A of trailing arm assembly 204 may be coupled to distal end 210B of boom tip 210, for example, via a rotatable or pivotable connection 218 (FIG. 2B). Rotatable or pivotable connection 218 may be configured to transition trailing arm assembly 204 between two or more configurations relative to boom tip 210, for example, between at least a folded or stowed configuration (FIG. 2A) and an unfolded or extended configuration (FIGS. 1 and 2B).

Although not shown, boom assembly 202 may include one or more of hydraulic systems, pneumatic systems, and/or busbar assemblies. Each of these one or more systems or assemblies may be located partially or entirely within a housing of main boom 208, coupled to a surface of main boom 208, adjacent to main boom 208, etc.

Trailing arm assembly 204 may include a plurality of arms, for example, rotatably or pivotably connected. For example, trailing arm assembly 204 may include at least a first arm 220 and a second arm 222. First arm 220 may be pivotably or rotatably coupled to distal end 210B of boom tip 210, and a proximal portion or end of second arm 222 may be pivotably or rotatably coupled to a distal portion or end of first arm 220. First arm 220 may be generally straight or planar, for example, with a longitudinal axis extending along a single plane. As labeled in FIG. 2B, second arm 222 may include a first generally straight or planar portion 222A and a second generally straight or planar portion 222B, for example, on proximal and distal ends of second arm 222, respectively. Furthermore, in some aspects, second arm 222 includes an angled portion 222C, for example, positioned between and connecting first portion 222A and second portion 222B and extending at a non-zero angle (e.g., between approximately 15 degrees to approximately 75 degrees, between approximately 30 degrees and approximately 60 degrees, for example, approximately 45 degrees) relative to both first portion 222A and second portion 222B. The connection between angled portion 222C and first portion 222A may form a first bent or knuckled portion 222D, and the connection between angled portion 222C and second portion 222B may form a second bent portion 222E.

Trailing arm assembly 204 may include or otherwise be coupled to a coupling arm 224. For example, a proximal end of coupling arm 224 may be coupled to (e.g., pivotably or rotatably coupled to) a distal end of second arm 222, and a distal end of coupling arm 224 may be coupled to (e.g., pivotably or rotatably coupled to) one or more portions of contactor assembly 206. In other aspects, one or more other portions of trailing arm assembly 204 (e.g., second arm 222) may be directly coupled to one or more portions of contactor assembly 206.

Contactor assembly 206 may be coupled to a distal end 204B of trailing arm assembly 204. Contactor assembly 206 may include a base frame 230 in which a plurality of conducting terminals 232 are secured. In an exemplary configuration, nine conducting terminals are arranged in a three-by-three matrix to provide redundancy and maintain electrical connection with conductor rails 112; however, conducting terminals may be arranged in different quantities and in other configurations. In the exemplary rail configuration of three conductor rails 112 and utilizing the three-by-three conducting terminal matrix, the plurality of conducting terminals are split into three equal groups of three conducting terminals arranged in a linear fashion. The three groups of linear conducting terminals each correspond to one of the positive polarity conductor rail, the negative polarity conductor rail, and the conductor rail providing a reference of 0 volts.

Based on the configuration of one or more of rotatable or pivotable connections 214, 216 trailing arm assembly 204 may transition between a folded or stowed configuration (FIG. 2) and an unfolded or extended configuration (FIGS. 1 and 2B), and vice versa. Moreover, one or more of these connections 214, 216 may be hydraulically, electrically, or pneumatically controlled. Alternatively or additionally, one or more of these connections 214, 216 may be controlled by one or more motors. Furthermore, the position or orientation of trailing arm assembly 204 and/or contactor assembly 206 may be actively controlled by one or more hydraulic systems, electrical systems, pneumatic systems, motors, etc., or passively controlled by springs, dampers, etc.

Additionally, as shown in FIG. 2A, one or more portions of rail connector assembly 200 may include one or more cable protectors 260. For example, adjacent cable protectors 260 may be coupled together, for example, to form a chain. Cable protectors 260 may extend along or adjacent to one or more portions of rail connector assembly 200. For example, as shown in FIG. 2A, cable protectors 260 may extend along or adjacent to a portion of trailing arm assembly 204. Cable protectors 260 may help to enclose or otherwise protect one or more cables, wires, or other conduits extending between, for example, contactor assembly 206 and machine frame 150 (e.g., along boom assembly 202, via one or more openings or channels in boom assembly 202, etc.). It is noted that cable protectors 260 are omitted in the other figures for clarity.

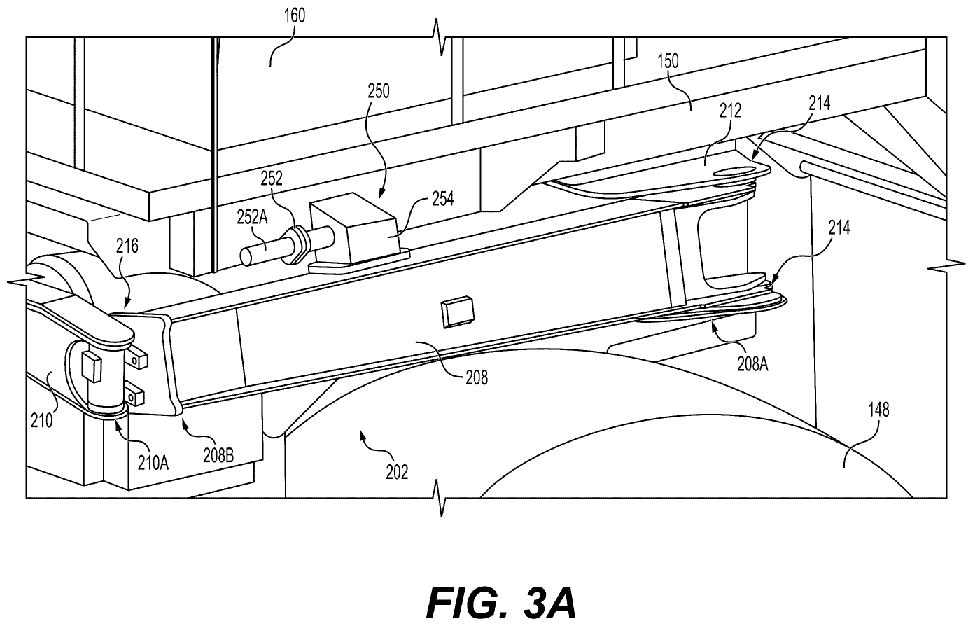

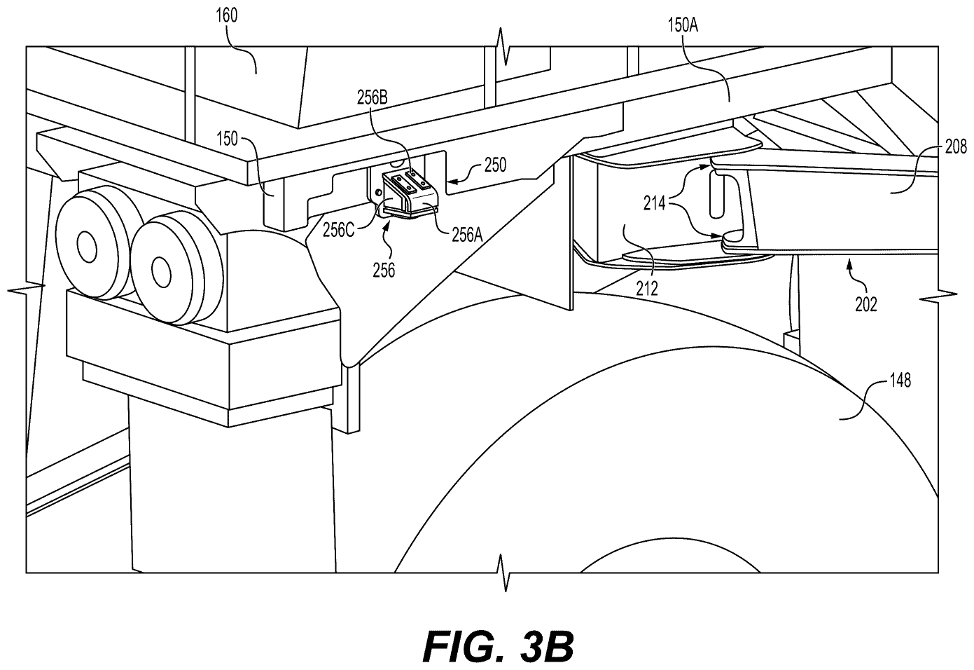

As mentioned above, mobile machine 130 and/or boom assembly 202 may include one or more boom lock assemblies 250, for example, transitionable or configured to actuate between an engaged locking configuration and an unengaged configuration. As shown in FIGS. 3A and 3B, boom lock assembly 250 includes a locking pin (not shown) that is movable within a pin housing 252. Pin housing 252 may include an expansion portion 252A, for example, to receive the locking pin when the locking pin is in a retracted position. Boom lock assembly 250 also includes a boom housing portion 254, for example, on a surface (e.g., a top surface) of main boom 208. For example, pin housing 252 may be attached to a top exterior surface of main boom 208 and may define a recessed space for receiving a lock portion of machine frame 150. The locking pin may be movable to extend at least partially within boom housing portion 254. Boom housing portion 254 may include a through hole for receiving and guiding the locking pin (e.g., from pin housing 252), such that the locking pin, when extended, is received through boom housing portion 254 and the portion of machine frame 150 in the recessed space. The portion of the frame 150 that is received by boom housing portion 254 may include a hole that is aligned with the hole of pin housing that receives the locking pin. In these aspects, the pin may help boom lock assembly 250 to be in an engaged locking configuration, thereby preventing boom assembly 202 from extending from machine frame 150.

Additionally, as shown in FIG. 3B, boom lock assembly 250 includes a machine frame housing portion 256, for example, coupled to side surface 150A of machine frame 150. It is noted that FIG. 3B illustrates boom assembly 202 at least partially extended from machine frame 150. In some aspects, machine frame housing portion 256 may include a size and/or shape that is at least partially complementary to a size and/or shape of boom housing portion 254. For example, machine frame housing portion 256 may include a distal surface 256A, a top surface 256B, and one or more side surfaces 256C. In these aspects, top surface 256B may taper downward toward distal surface 256A, for example, with a rounded distal end connecting top surface 256B to distal surface 256A. Correspondingly, the height of side surface(s) 256C may taper or narrow, for example, from machine frame 150 to distal surface 256A. In these aspects, machine frame housing portion 256 may be at least partially received within a portion of boom housing portion 254, for example, to interact with the pin. Additionally, the pin may interact with one or more portions of machine frame housing portion 256, for example, to help maintain boom assembly 202 in the retracted or stowed position (FIGS. 2A and 3A).

In some aspects, the positions and/or orientations of the pin and the components of boom lock assembly 250 may be repositioned and/or reversed. For example, instead of the pin being movably position on boom assembly 202, the pin may be movably positioned on machine frame 150. Furthermore, in some aspects, the movement of the pin may be hydraulically, pneumatically, or otherwise controlled, for example, by one or more operator input (e.g., in operator cabin 160).

Although not shown, one or more of machine frame 150 and/or boom assembly 202 may include one or more sensors (e.g., proximity sensors), for example, to help detect, signal, or otherwise indicate a position of boom assembly 202 relative to machine frame 150. In some aspects, boom lock assembly 250 may include one or more sensors, for example, to detect the position of the pin within boom lock assembly 250. In other aspects, one or more of boom assembly 202, trailing arm assembly 204, and/or contactor assembly 206 may include one or more angular position sensors, orientation sensors, inertial measurement sensors (IMUs), etc., for example, to help provide one or more references for the relative locations and/or positions.

### INDUSTRIAL APPLICABILITY

The disclosed aspects of the pivoting boom above can be used for deploying a rail connector assembly and charging a moving free-steering machine, for example, with energy from an electrically-conducting rail system on an industrial worksite. In order to operate mobile machine 130, mobile machine 130 is controlled by an operator, either remotely or present in operator cabin 160. Upon approaching electrically-conducting rail system 120, rail connector assembly 200 may be deployed (e.g., from the retracted or stowed configuration shown in FIG. 2). This deployment may be the result of the operator initiating the deployment or may occur autonomously via a signal generated due to the mobile machine's geographic location (e.g., a position identified with a global navigation satellite system) and proximity to rails 122. Additionally, in some aspects, the deployment may include unlocking boom lock assembly 250, for example, by retracting (e.g., hydraulically) the locking pin within pin housing 252.

As discussed above, boom assembly 202 includes main boom 208 and boom tip 210, and boom tip 210 may include one or more angled portions 210C extending at a non-zero angle relative to main boom 208 forming bent portion 210E. As a result, the remaining components of rail connector assembly 200 (e.g., trailing arm assembly 204 and/or contactor assembly 206) may be elevated above a ground surface (e.g., positioned with a greater clearance) and/or positioned closer to one or more portions of machine frame 150 (e.g., operator cabin 160) than if boom tip 210 did not include any angled portions. In these aspects, trailing arm assembly 204 and/or contactor assembly 206 may be spaced away from dirt, rocks, obstacles, and/or other materials on or kicked up from the ground surface as mobile machine 130 traverses the ground. Trailing arm assembly 204 and/or contactor assembly 206 may also be positioned away from bed 132, for example, helping to protect trailing arm assembly 204 and/or contactor assembly 206 during loading, travel, and/or unloading. In some aspects, the orientation of boom tip 210 relative to main boom 208 may be adjustable. The adjustability may help to allow for rail connector assembly 200 to be coupled to different machines (e.g., different sizes of machines, different types of machines, etc.), while still helping to allow for an appropriate positioning of trailing arm assembly 204 and, correspondingly, contactor assembly 206 relative to conductor rails 122. Moreover, boom tip 210 may be replaced with a similar boom tip 210 having larger or smaller dimensions depending on the mobile machine 130 to which it is connected (e.g., boom tip 210 may be replaced while boom 208, trailing arm assembly 204, and contactor assembly 206 remain the same). That is, boom tip 210 may be removably coupled to a remainder of boom assembly 202. For example, a first boom tip 210 may be replaced with a second boom tip 210. Second boom tip 210 may be longer or shorter than first boom tip 210. As such, by way of example only, larger machines may utilize a longer boom tip while smaller machines may utilize a shorter boom tip 210, which may accommodate traction or slipping events of various sizes of machines.

Furthermore, boom tip 210 may help for contactor assembly 206 to be elevated from the ground surface when rail connector assembly 200 is in the pivoted or extended configuration (FIGS. 1 and 2B). For example, contactor assembly 206 may be positioned to a height above or to the height of conductor rails 122 based on bent portion 210E of boom tip 210. In some aspects, conductor rails 122 may be spaced above the ground surface to allow for people or machinery to pass under conductor rails 122, but contactor assembly 206 may be positioned above or to the height of conductor rails 122. In some arrangements, however, boom tip 210 may be replaced with a straight (e.g., non-angled) boom tip

In some aspects, various aspects of rail connector assembly 200 may help to position portions of rail connector assembly 200 relative to machine frame 150. For example, various aspects of rail connector assembly 200 may help to position trailing arm assembly 204 and/or contactor assembly 206 at a position in front of (e.g., adjacent to a front portion of machine frame 150) and/or below operator cabin 160 (FIG. 2A), which may not impair or otherwise interfere with an operator's field of view and/or sightlines. Similarly, the position of various portions of rail connector assembly 200 may not impair or otherwise interfere with the field of view or sightlines of one or more sensors coupled to mobile machine 130 (e.g., stringline sensors, cameras, proximity sensors, etc.) on machine frame 150, and/or observation from a position remote to mobile machine 130 (e.g., when operated remotely). Additionally, angled portion 222C and/or bent portions 222D, 222E of trailing arm assembly 204 may help to allow for trailing arm assembly 204 to fold and/or at least partially overlap, for example, reducing the size or footprint, in the retracted or stowed configuration. In these aspects, when in the retracted or stored position, trailing arm assembly 204 and/or contactor assembly 206 may be spaced away from bed 132 and/or the material stored in bed 132. For example, trailing arm assembly 204 and/or contactor assembly 206 may be protected from the material during loading, transport (e.g., as some material may fall out), and/or dumping.

Additionally, the mounting position of main boom 208 relative to machine frame 150 and/or the angle of boom tip 210 relative to main boom 208 may help to account for machine frame 150 lowering in height during use (e.g., when bed 132 is loaded with material(s)). In these aspects, the components of rail connector assembly 200 may be positioned closer to machine frame 150 and/or farther away from the ground surface, both in the retracted or stowed configuration (e.g., FIG. 2) and a pivoted or extended configuration (FIG. 1).

Furthermore, in some aspects, boom assembly 202 may be coupled to machine frame 150 in a middle position of machine frame 150, for example, to one or more beams (e.g., rollover protection system (ROPS) beams or supports). For example, boom assembly 202 may be coupled to machine frame 150 at a position close to the center of gravity of mobile machine 130. In these aspects, the coupling of boom assembly 202 to machine frame 150 may help to reduce a risk of mobile machine 130 rolling over or otherwise being off-balance, both with rail connector assembly 200 in the retracted or stowed configuration and with rail connector assembly 200 in a pivoted or extended configuration. Additionally, in some aspects, rail connector assembly 200 may be coupled to an existing mobile machine, for example, by retrofitting the existing mobile machine by coupling rail connector assembly 200 to existing portion(s) of the frame of the existing mobile machine frame.

In all of these aspects, rail connector assembly 200 may help mobile machine 130 to rapidly deploy and/or engage rail connector assembly 200 onto an electrically-conducting rail system. Rail connector assembly 200 may be used with multiple types of mobile machines 130 to supply electrical energy from electrically-conducting rail system 120, which may be positioned to a side of mobile machine (e.g., adjacent to portion of the work route or path). For example, rail connector assembly 200 may help to convey electrical energy (e.g., via contactor assembly 206, various electrical conduits, busbars or other conduits through boom assembly 202, etc.) and help to charge battery system 146 of mobile machine 130.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail connector assembly for connecting a mobile machine to an electrically-conducting rail system, the rail connector assembly comprising:
a boom assembly, including a main boom and a boom tip, wherein a first end of the main boom is configured to be coupled to the mobile machine, wherein a second end of the main boom opposite to the first end is pivotably coupled to the boom tip, and wherein the boom tip includes an angled portion that extends at a non-zero angle from a longitudinal axis of the main boom;
a trailing arm assembly, wherein the trailing arm assembly is pivotably coupled to an end of the boom tip; and
a contactor assembly, wherein the contactor assembly is pivotably coupled to an end of the trailing arm assembly.

2. The rail connector assembly of claim 1, wherein the angled portion of the boom tip extends at approximately 45 degrees from the longitudinal axis of the main boom.

3. The rail connector assembly of claim 1, wherein trailing arm includes at least a first arm and a second arm, and wherein the second arm includes an angled portion that extends at non-zero angles from both first and second end portions of the second arm.

4. The rail connector assembly of claim 1, further comprising a boom bracket, wherein the boom bracket is configured to couple the first end of the main boom to a machine frame.

5. The rail connector assembly of claim 1, further including a locking assembly on an exterior surface of the main boom, wherein the locking assembly is configured to actuate between an unengaged configuration and an engaged locking configuration.

6. The rail connector assembly of claim 5, wherein, when the boom assembly is extended from the mobile machine, the locking assembly is configured to be in an unengaged configuration, and
wherein, when the boom assembly is in a retracted configuration against a frame of the mobile machine, the locking assembly is configured to be in an engaged locking configuration, thereby preventing the boom assembly from extending from the frame.

7. The rail connector assembly of claim 1, wherein the connector assembly further includes one or more cable protectors that at least partially overlap with one or more portions of the trailing arm assembly.

8. The rail connector assembly of claim 1, wherein the boom tip is removably coupled to a remainder of the boom assembly such that a first boom tip may be replaced by a second boom tip, wherein the second boom tip has a different length than the first boom tip.

9. An electrically-powered mobile machine, the electrically-powered mobile machine comprising:
a machine frame;
a motor configured to operate a function of the mobile machine; and
a connector assembly coupled to a portion of the machine frame via a boom bracket, wherein the connector assembly is configured to connect to an electrically-conductive rail for supplying electrical energy to at least one of a storage device or the motor,
wherein the connector assembly includes:
a boom assembly, including a main boom and a boom tip, wherein a first end of the main boom is configured to be coupled to the mobile machine, wherein a second end of the main boom opposite to the first end is pivotably coupled to the boom tip, and wherein the boom tip includes an angled portion that extends at a non-zero angle from a longitudinal axis of the main boom;
a trailing arm assembly, wherein the trailing arm assembly is pivotably coupled to an end of the boom tip; and
a contactor assembly, wherein the contactor assembly is pivotably coupled to an end of the trailing arm assembly.

10. The electrically-powered mobile machine of claim 9, wherein the angled portion of the boom tip extends at approximately 45 degrees from the longitudinal axis of the main boom.

11. The electrically-powered mobile machine of claim 9, wherein trailing arm includes at least a first arm and a second arm, and wherein the second arm includes an angled portion that extends at non-zero angles from both first and second end portions of the second arm.

12. The electrically-powered mobile machine of claim 9, wherein the electrically-powered mobile machine includes an operator cabin, and wherein the main boom is coupled to a side of the machine frame at a position below or behind the operator cabin.

13. The electrically-powered mobile machine of claim 12, wherein, in a stowed configuration, the trailing arm assembly and the contactor assembly are positioned in front of the operator cabin.

14. The electrically-powered mobile machine of claim 9, wherein the connector assembly further includes one or more cable protectors that at least partially overlap with one or more portions of the trailing arm assembly.

15. The electrically-powered mobile machine of claim 14, wherein the one or more cable protectors includes a plurality of cable protectors.

16. The electrically-powered mobile machine of claim 9, further including a locking assembly, wherein the locking assembly includes a boom housing portion and a machine frame housing portion, wherein the boom housing portion is positioned on an exterior surface of the main boom, wherein the machine frame housing portion is positioned on an exterior surface of the machine frame, and wherein the locking assembly is configured to actuate between an unengaged configuration and an engaged locking configuration.

17. The electrically-powered mobile machine of claim 16, wherein the machine frame housing portion includes a tapered surface that is at least partially complementary to a shape of the boom housing portion.

18. A rail connector assembly for connecting a mobile machine to an electrically-conducting rail system, the rail connector assembly comprising:
a boom assembly, including a main boom and a boom tip, wherein a first end of the main boom is configured to be coupled to the mobile machine, wherein a second end of the main boom opposite to the first end is pivotably coupled to the boom tip;
a trailing arm assembly, wherein the trailing arm assembly is pivotably coupled to an end of the boom tip, and wherein the trailing arm includes at least a first arm and a second arm, and wherein the second arm includes an angled portion that extends at non-zero angles from both first and second end portions of the second arm;
a contactor assembly, wherein the contactor assembly is pivotably coupled to an end of the trailing arm assembly; and
a plurality of cable protectors that at least partially overlap with one or more portions of the trailing arm assembly.

19. The rail connector assembly of claim 18, wherein the boom tip includes an angled portion that extends at approximately 45 degrees from a longitudinal axis of the main boom.

20. The rail connector assembly of claim 18, further including a locking assembly on an exterior surface of the main boom, wherein the locking assembly is configured to actuate between an unengaged configuration and an engaged locking configuration, when the boom assembly is extended from the mobile machine, the locking assembly is configured to be in an unengaged configuration, and
wherein, when the boom assembly is in a retracted configuration against a frame of the mobile machine, the locking assembly is configured to be in an engaged locking configuration, thereby preventing the boom assembly from extending from the frame.
